(19) United States
(12) Patent Application Publication
(10) Pub. No.: US 2007/0058057 A1
(43) Pub. Date: Mar. 15, 2007

(54) Solid state imaging device and operation method of the same

(75) Inventor: Fumiaki Futamura, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/226,202

(22) Filed: Sep. 15, 2005

(30) Foreign Application Priority Data
Sep. 15, 2005 (JP) 2004-268859

(51) Int. Cl. H04N 5/335; H04N 3/14

(52) U.S. Cl. 348/294

(57) ABSTRACT

A solid state imaging device includes a floating diffusion layer, a reset drain, and an absorption drain formed in a semiconductor substrate. The solid state imaging device further includes a charge transfer section to transfer electric charge into the layer in response to a clock signal; a reset transistor to transfer the electric charge from the layer into the reset drain in response to a Pulse signal; a barrier transistor to transfer the electric charge from the reset drain into the absorption drain; a boosting circuit to bias the absorption drain to a predetermined voltage based on the clock signal; a timing control circuit to stop supply of the clock signal to the boosting circuit and the charge transfer section, and to restart supply of the pulse signal to the reset transistor at a time prior to restart of the supply of the clock signal at a second time.

### BACKGROUND OF THE INVENTION

1. Field of the Invention

The present invention relates to a solid state imaging device and an operation method of a solid state imaging device.

2. Description of the Related Art

A digital image photographic apparatus mounted with a solid state imaging device such as a digital still camera and a digital video camera has come into wide use. The solid state imaging device contains a CCD (Charge Coupled Device), an amplifier that amplifies an output of the CCD, an A/D converter that converts an output from the amplifier into a digital signal, and the like.

The CCD contains light receiving elements such as photo diodes, and a charge transfer section that transfers electric charges generated by the light receiving elements. The charge transferred by the charge transfer section is supplied to a charge detecting section. The charge detecting section converts the supplied charges into an electrical signal corresponding to the supplied charge, to output the electrical signal to the amplifier. The amplifier amplifies and outputs the electrical signal supplied from the charge detecting section.

As a method of detecting the charge by the use of the charge detecting section, a FDA (Floating Diffusion Amplifier) method is generally used. In the FDA method, the transferred charge is detected by detecting a potential change of a floating diffusion layer that is provided in a subsequent stage of a charge transfer section, as shown in Japanese Laid Open Patent Application (JP-A-Heisei 6-338525). An output signal is outputted from the floating diffusion layer. Then, the charge in the floating diffusion layer is necessary to be reset or discharge. Therefore, a reset transistor is provided for the charge transfer section using the FDA method.

When the charge transfer section is formed in a P-type semiconductor substrate, a reset transistor is formed from the floating diffusion layer, a reset drain, and a reset gate electrode. The reset transistor forms an N-channel region when a reset pulse is applied to the reset gate electrode and discharges the charge from the floating diffusion layer into the reset drain. The amplitude of the reset pulse applied to the reset gate is made larger than that of a charge transfer clock to perform a reset operation without fail.

By the way, in a semiconductor circuit, a lower voltage operation is requested. Such a request of the lower voltage operation is no exception even for the above-mentioned CCD. In order to cope with the request for the lower voltage operation and a single power supply in the CCD, in the above-mentioned Japanese Laid Open Patent Application (JP-A-Heisei 6-338525), a floating diffusion layer, a reset drain, and an absorption drain are provided in a surface region of a semiconductor substrate in a subsequent stage of charge transfer section that contains an n-type diffusion layer 12, transfer gate electrodes 14 and 15, and an output gate 16. A reset gate electrode is provided above a semiconductor substrate between the floating diffusion layer and the reset drain, while a barrier gate electrode is provided above the semiconductor substrate between the reset drain and the absorption drain. A resistance R is connected to the reset drain to discharge charge. A reset pulse with 5V as an H level and 0V as an L level is applied to the reset gate electrodes. A power supply voltage VB (5V) is applied to the barrier gate electrode, while an output voltage (12V) of a boosting circuit is applied to the absorption drain. Since the barrier transistor is in an on state at all times in this charge transfer section, a potential of the reset drain is kept to the potential of a channel region in the barrier transistor. The boosting circuit is formed by connecting rectifier circuits of diodes in multiple stages, and is applied with a transfer clock (not shown).

In such a solid state imaging device, when readout of charge from the light receiving element (photo diode) to the charge transfer section provided in the solid state imaging device is performed, the charge transfer section does not need to carry out its operation. Therefore, a transfer clock signal is stopped when the readout of charges from the light receiving element is carried out. Also, it is not necessary to operate the reset transistor, since the charge transfer is not carried out. Further, the boosting circuit also stops the charge transfer operation since the transfer clock is stopped.

In the solid state imaging device in the above-mentioned Japanese Laid Open Patent Application (JP-A-Heisei 6-338525), a signal voltage is supplied through a CCD output terminal from the floating diffusion layer to an amplifier circuit to obtain a signal output. The amplifier circuit is provided with a clamp circuit that applies an offset voltage to the signal voltage. In the same way as in the reset transistor and the boosting circuit, the clamp circuit does not need to operate when the readout of charge is carried out. Therefore, the clamp circuit stops its operation. An operation during such a period during which the readout of charge is carried out, namely, the operation when the transfer clock signal is stopped, is described next with reference to FIGS. 1A to 1G. FIGS. 1A to 1G are timing charts showing the operation when the transfer clock is stopped in a conventional charge transfer section. As shown in FIGS. 1A to 1G, the transfer clock signals Φ1 and Φ2 to be supplied to transfer gate electrodes, a reset pulse ΦR to be supplied to the reset gate electrode and a clamp pulse ΦCLP that is supplied to the clamp circuit, are stopped at a time t1. If the transfer clock signals Φ1 and Φ2 are stopped, the operation of the boosting circuit is stopped and an output voltage V_{RD0} applied from the boosting circuit to the absorption drain decreases gradually.

Originally, a reset drain voltage V_{RD1} does not change since a constant voltage is applied to the gate electrode of the barrier transistor. However, if a gate length L of the barrier transistor is shortened in order to promptly discharge the charge stored in the floating diffusion layer to the reset drain, the reset drain voltage V_{RD1} decreases as the output voltage of the boosting circuit decreases.

Because the reset drain voltage V_{RD1} decreases lower than the original voltage, the offset voltage of the signal output Vout is also made lower than a predetermined voltage. If supply of the transfer clock signal is restarted in this state at a time t2, several bits in the beginning are not clamped to a desired voltage. Thus, it becomes difficult to obtain a desired output waveform from valid pixels.

In order to obtain the desired output waveform from the valid pixels as mentioned above, a technique is known to use invalid pixels provided for the solid state imaging device. In this technique, it is possible to stabilize the offset voltage until the signal voltage is generated based on the charges from the valid pixels. However, a circuit area of the solid state imaging device becomes larger if the invalid pixels are provided.

### SUMMARY OF THE INVENTION

In an aspect of the present invention, a solid state imaging device includes a floating diffusion layer, a reset drain, and an absorption drain formed in a semiconductor substrate. The solid state imaging device further include a charge transfer section configured to transfer electric charge into the floating diffusion layer in response to a transfer clock signal; a reset transistor configured to transfer the electric charge from the floating diffusion layer into the reset drain in response to a reset pulse signal; a barrier transistor configured to transfer the electric charge from the reset drain into the absorption drain; a boosting circuit configured to bias the absorption drain to a predetermined voltage based on the transfer clock signal; a timing control circuit configured to stop supply of the transfer clock signal to the boosting circuit and the charge transfer section, and to restart supply of the reset pulse signal to the reset transistor at a first time prior to restart of the supply of the transfer clock signal at a second time.

Here, the solid state imaging device may further include an amplifying circuit connected with the floating diffusion layer to amplify a voltage signal based on the electric charge in the floating diffusion layer; a capacitor configured to cut a DC component from the amplified voltage signal; and a clamping circuit configured to apply a reference voltage to an output of the capacitor in response to a clamp pulse signal. The timing control circuit supplies the clamp pulse signal.

In this case, the timing control circuit may supply the clamp pulse signal when supplying the reset pulse signal and stops the supply of the clamp pulse signal when stopping the supply of the reset pulse signal.

Also, the first time is preferably predetermined such that an output signal of the solid state imaging device corresponding to the electric charge stored in the floating diffusion layer has a reference voltage.

Also, the transfer clock signal may include a first transfer clock signal and a second transfer clock signal.

Also, the reset transistor may be formed from the floating diffusion layer, the reset drain, and a reset gate electrode supplied with the reset pulse signal, and the barrier transistor may be formed from the reset drain, the absorption drain and a barrier gate electrode supplied with a constant voltage.

Also, the timing control circuit may stop the supply of the transfer clock signal to the boosting circuit and the charge transfer section when the electric charge is read out from a pixel to the charge transfer section.

In another aspect of the present invention, an operation method of a solid state imaging device is achieved by transferring electric charge into a floating diffusion layer of a charge transfer section in response to a transfer clock signal; by transferring the electric charge from the floating diffusion layer into a reset drain in response to a reset pulse signal; by transferring the electric charge from the reset drain into an absorption drain; by biasing the absorption drain to a predetermined voltage based on the transfer clock signal to absorb the electric charge; by stopping generation of the transfer clock signal; and by restarting the generation of the reset pulse signal at a first time prior to restart of the generation of the transfer clock signal at a second time.

Here, the operation method may be achieved by further amplifying a voltage signal based on the electric charge in the floating diffusion layer; cutting a DC component from the amplified voltage signal; applying a reference voltage to an output of the capacitor in response to a clamp pulse signal; and generating the clamp pulse signal.

Also, the generating may be achieved by generating the clamp pulse signal when the reset pulse signal is generated; and by stopping the generation of the clamp pulse signal when the supply of the reset pulse signal is stopped.

Here, the first time is preferably predetermined such that an output signal of the solid state imaging device corresponding to the electric charge stored in the floating diffusion layer has a reference voltage.

Also, the transfer clock signal may include a first transfer clock signal and a second transfer clock signal.

Also, a reset transistor may be formed from the floating diffusion layer, the reset drain, and a reset gate electrode supplied with the reset pulse signal, and a barrier transistor may be formed from the reset drain, the absorption drain and a barrier gate electrode supplied with a constant voltage.

Also, the stopping generation of the transfer clock signal may be achieved by stopping the generation of the transfer clock signal when the electric charge is read out from a pixel to the charge transfer section.

### BRIEF DESCRIPTION OF THE DRAWINGS

FIGS. 1A to 1G are timing charts showing an operation when a transfer clock signal is stopped in a conventional charge transfer section;

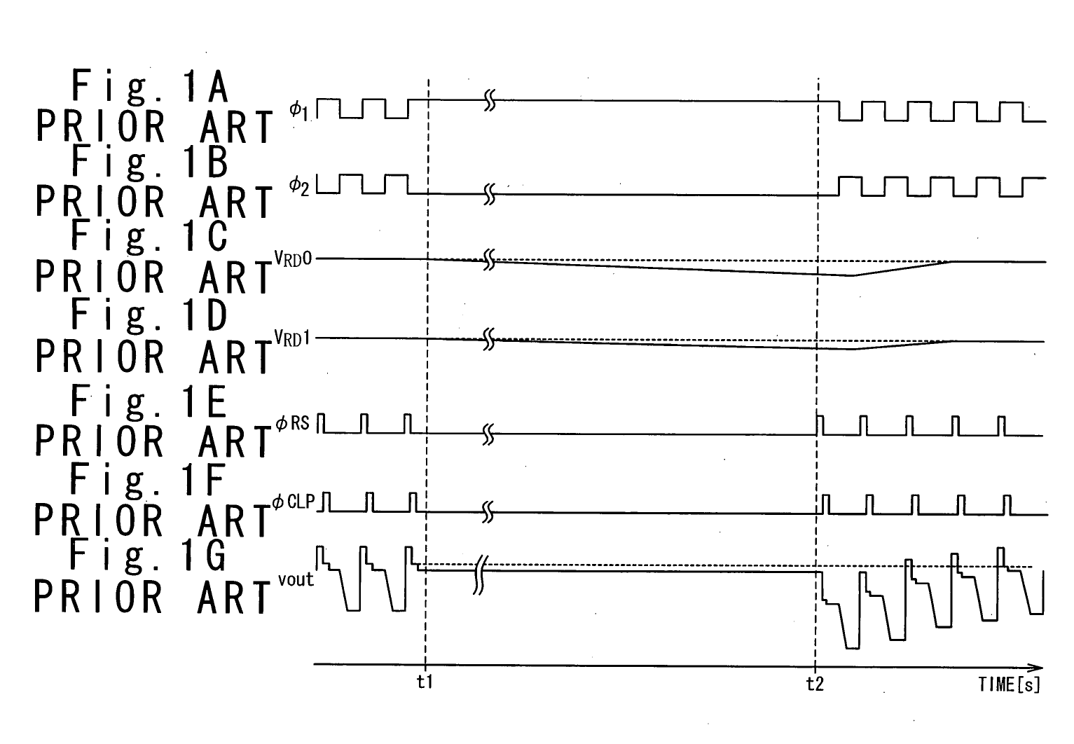

FIG. 2 is a sectional view showing the configuration of a charge transfer section of the solid state imaging device according to an embodiment of the present invention;

FIG. 3 is a block diagram showing the configuration of the solid state imaging device according to the embodiment of the present invention; and

FIGS. 4A to 4G are timing charges showing an operation of the solid state imaging device in the embodiment of the present invention.

### DESCRIPTION OF THE PREFERRED EMBODIMENTS

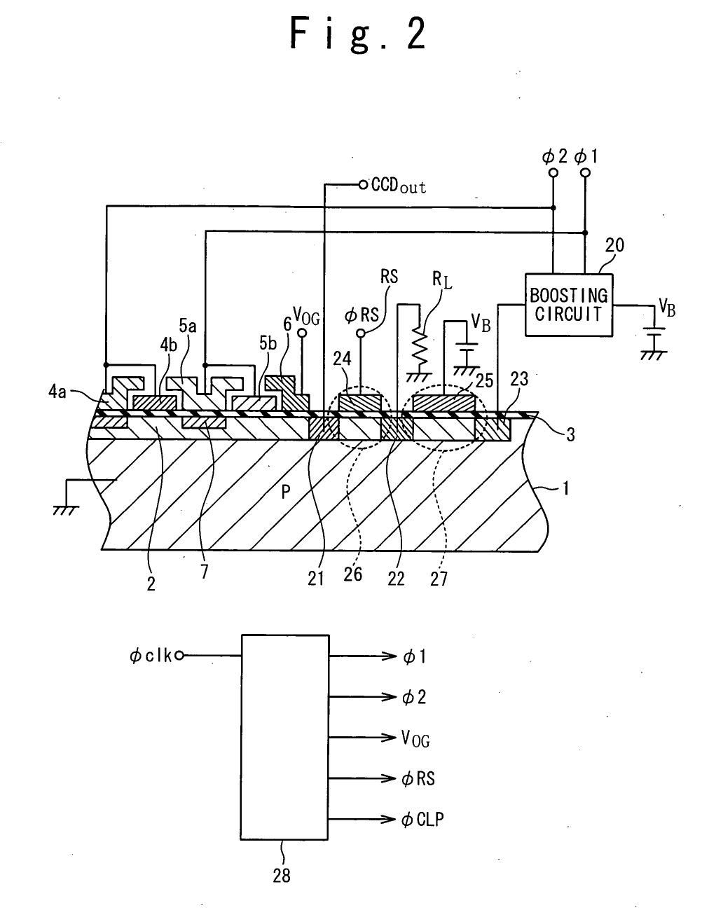

Hereinafter, a solid state imaging device such as a charge coupled device of the present invention will be described in detail with reference to the attached drawings. FIG. 2 is a sectional view showing the configuration of a charge transfer section of the solid state imaging device according to the embodiment of the present invention in the vicinity of an output stage. It is preferable that the charge transfer section described below is a buried-channel type charge transfer section. As shown in FIG. 2, a charge transfer section 10 in the embodiment contains an n-type diffusion region 2 as a charge transfer region that is formed on a p-type semiconductor substrate 1, to transfer electric charge read out from a pixel (not shown). A gate insulating film 3 is formed on the n-type diffusion region 2.

Transfer gate electrodes 4a, 4b, 5a, and 5b are formed on the insulating film 3 from an upstream side to a downstream side in this order. A part of the transfer gate electrodes 4a and 5a is formed to cover the transfer gate electrode 4b, and a part of the transfer gate electrode 5a and a readout gate electrode 6 is formed to cover the transfer gate electrode 5b. A reset gate electrode 24 is formed on the insulating film 3 apart from the readout gate electrode 6, and a barrier gate electrode 25 is formed on the insulating film 3 apart from the reset gate electrode 24.

A barrier layer 7 is formed in a surface region of the n-type diffusion region 2 directly below each of the transfer gate electrodes 4a and 5a. Thus, the transfer gate electrodes 4a and 5a have shallow potential wells, while the transfer gate electrodes 4b and 5b have deep potential wells. A floating diffusion layer 21 is formed in a region of the n-type diffusion region 2 between the readout gate electrode 6 and the reset gate electrode 24. A reset drain 22 is formed in a region of the n-type diffusion region 2 between the reset gate electrode 24 and the barrier gate electrode 25. An absorption drain 23 is formed in a region of the n-type diffusion region 2 from the barrier gate electrode 25. Thus, a reset transistor 26 is formed from the floating diffusion layer 21, the reset gate electrode 24, and the reset drain 22, and a barrier transistor 27 is formed from the reset drain 22, the barrier gate electrode 5, and the absorption drain 23. In this configuration, the reset transistor 22 resets the charge stored the floating diffusion layer 21 and the absorption drain 23 stabilizes the voltage of the reset drain 22. The barrier transistor 27 is always operable since a constant voltage is applied to the barrier gate electrode 25.

The solid state imaging device of the present invention further includes a timing control circuit 28 and a boosting circuit 20. The timing control circuit 28 receives a main clock signal Φclk and generates first and second transfer clock signals Φ1 and Φ2, a readout gate signal V_{OG}, a reset pulse signal ΦRS and a clamp pulse signal ΦCLP. The reset pulse signal ΦRS is a clock that is in phase with the first transfer clock signal Φ1, having a high level period shorter than that of the first transfer clock signal Φ1, and 5V as the high level and 0V as the low level. The boosting circuit 20 receives the first and second transfer clock signals Φ1 and Φ2, and generates a boosted voltage V_{DR0} of 12V. Thus, the boosting circuit 20 does not operate or stops its operation when the first and second transfer clock signals Φ1 and Φ2 are supplied. The first transfer clock signal Φ1 is supplied to the transfer gate electrodes 5a and 5b, and the second transfer clock signal Φ2 is supplied to the transfer gate electrodes 4a and 4b. Thus, a pair of the first transfer gate electrodes 5a and 5b operates in synchronization with the first transfer clock signal Φ1, and a pair of the second transfer gate electrodes 4a and 4b operates in synchronization with the second transfer clock signal Φ2. The readout gate signal V_{OG} is supplied to the readout gate electrode 6, and the reset pulse signal ΦRS is supplied to the reset gate electrode 24. The reset drain 22 is connected with a resistance R_{L} and the barrier gate electrode 25 is connected with a constant voltage source V_{B}. The output V_{DRO} of the boosting circuit 20 is connected with the absorption drain 23. The floating diffusion layer 21 is connected with a terminal CCDout.

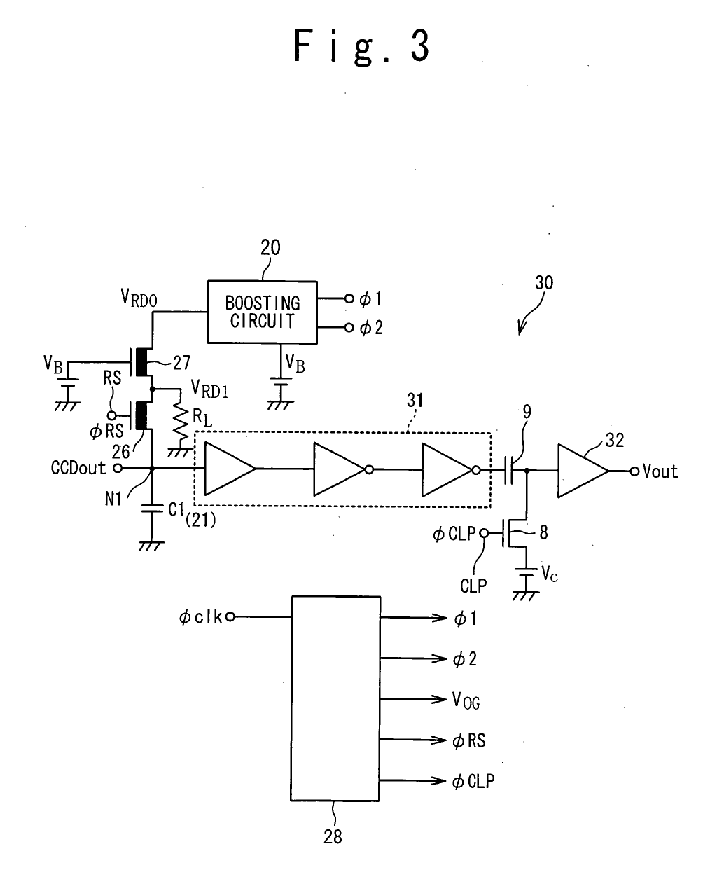

Next, the configuration of an amplifier circuit in the solid state imaging device of the present invention will be described with reference to FIG. 3. As shown in FIG. 3, the floating diffusion layer 21 stores charge read out from a pixel (not shown) and transferred by the transfer gate electrodes 4a, 4b, 5a, and 5b and the readout gate electrode 6. Therefore, the floating diffusion layer 21 is shown as a capacitor C1 in FIG. 3. The boosting circuit 20 receives the first and second transfer clock signals Φ1 and Φ2, and generates the boosted voltage V_{DRO} of 12V. The boosted voltage V_{DRO} is supplied to the absorption drain 23 of the barrier transistor 27. The barrier gate electrode 25 of the barrier transistor 27 is supplied with the constant voltage V_{B}. The reset drain 22 as a source of the barrier transistor 27 is connected with the resistance R_{L}. The reset gate electrode 24 of the reset transistor 26 is supplied with the reset pulse signal ΦRS. The floating diffusion layer 21 functions as a source of the reset transistor 26 and is connected with a node N1. An amplifier 31 is connected with the node N1 and receives a signal voltage corresponding to the charge stored in the floating diffusion layer 21, and amplifies and outputs the signal voltage. The amplified signal voltage is supplied to an input of a buffer 32 via a capacitor 9. The capacitor 9 cuts off a DC component. A clamp circuit is connected with a node between the capacitor 9 and the input of the buffer 32 to apply a clamp voltage. The clamp circuit is composed of a clamp transistor 8 and a constant voltage source Vc. The gate of the clamp transistor 8 is supplied with the clamp pulse signal ΦCLP. The clamp circuit applies a clamp voltage to the output Vout from the buffer 32. It is preferable that the clamp transistor 8 has a low driving capability in order to control clamp noise. It is preferable that the amplifier circuit 30 is provided on the same chip as the charge transfer section 10. The embodiment uses a circuit configuration for clamping, and the clamp circuit is arranged in a subsequent stage of the amplifier 31. However, it may be also possible to use a circuit configuration for directly clamping detecting output of the floating diffusion layer 21, and the clamp circuit 8 is arranged in a front stage of the amplifier 31.

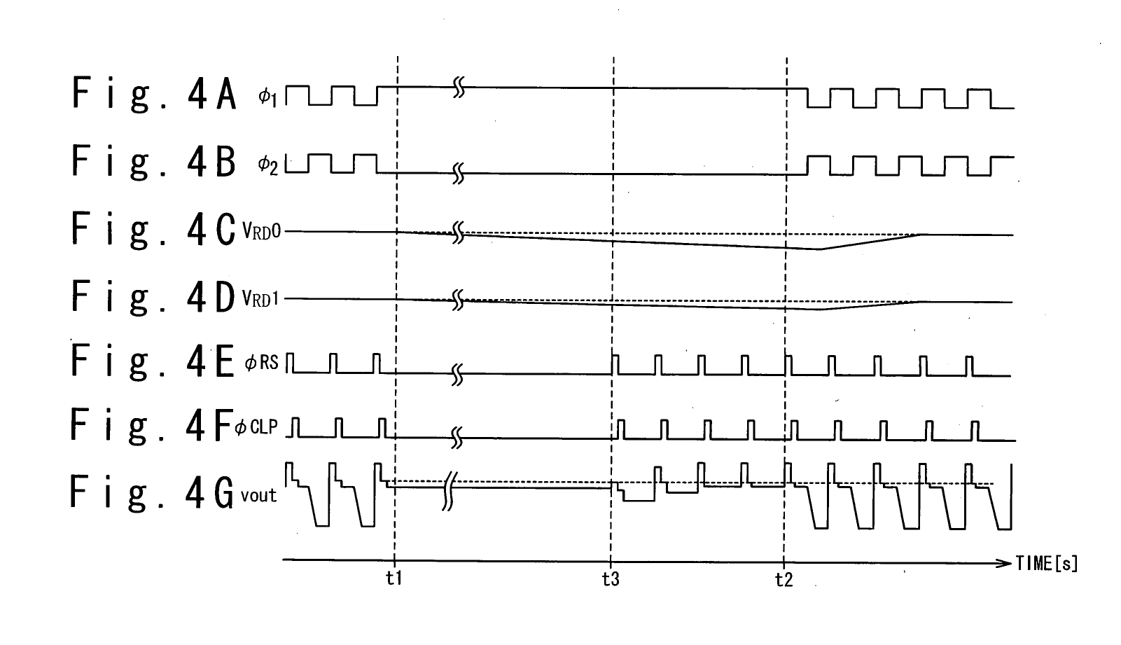

An operation of the solid state imaging device in the embodiment of the present invention will be described below with reference to FIGS. 4A to 4G. The solid state imaging device in the embodiment is provided with a plurality of valid pixels (photo diode) arranged in an array form. Unlike the conventional example, any invalid pixel is not provided. When charges read out from the plurality of pixels, the timing control circuit 28 stops the generation of the first transfer clock signal Φ1 and the second transfer clock signal Φ2 in order to reduce power consumption of the state imaging device. Therefore, the supply of the first transfer clock signal Φ1 and the second transfer clock signal Φ2 to the boosting circuit 20 is also stopped during a period in which the charges are read out from the plurality of pixels. Also, the timing control circuit 28 stops the supply of the clamp pulse signal ΦCLP and the reset pulse signal ΦRS since the charge transfer is not carried out. As shown in FIGS. 4A to 4G, the output voltage V_{RD0} of the boosting circuit 20 applied to the absorption drain decreases gradually when the boosting circuit 20 stops its operation at the time t1.

The reset drain voltage V_{RD1} ought not change originally since the constant voltage VB is applied to the gate of the barrier transistor 27. However, when the gate length L of the reset transistor 26 is shortened in order to promptly discharge the charges stored in the floating diffusion layer 21 to the reset drain 22, the reset drain voltage V_{RD1} is easily influenced by the change of the output voltage V_{RD0} of the boosting circuit 20 and the reset drain voltage V_{RD1} also changes accordingly.

Here, at a time t3 prior to the time t2, the timing control circuit 28 supplies the reset pulse ΦRS to the reset gate electrode 24. Further, the timing control circuit 28 supplies the clamp pulse signal ΦCLP to the clamp transistor 8 of the clamp circuit in synchronization with the reset pulse signal ΦøRS.

In this way, as shown in FIG. 4, by supplying the reset pulse signal ΦRS and the clamp pulse signal ΦCLP in advance, a potential change in the floating diffusion layer 21 can be compensated. Consequently, it is possible to set the potential of the output terminal Vout to the reference offset at the time t2 even with the clamp transistor 8 of weak driving ability. Therefore, the desired output waveform can be obtained from the valid pixels when the supply of the transfer clock signals are restarted, without providing the invalid pixels. It should be noted that the time t3 when the timing control circuit 28 restarts the supply of the reset pulse signal ΦRS and the clamp pulse signal ΦCLP is set such that the output terminal Vout has a predetermined potential level at the time t2 when the first transfer clock Φ1 and the second transfer clock Φ2 are again supplied. Further, this setting can optionally be changed. The clamp pulse signal may be kept to a stopped state if the supply of the reset pulse signal ΦRS is restarted. However, since the capacitor 9 exists, it is preferable to restart the supply of the clamp pulse signal ΦCLP at the time t3.

It should be noted that it is possible not to stop the supply of the reset pulse signal ΦRS and the clamp pulse signal ΦCLP, when the control of power consumption is unnecessary. In addition, in the embodiment of the present invention, the same clock signals are used for the charge transfer electrodes and the boosting circuit 20, but it could be understood to a person skilled in the art that the clock signals does not need to be the same.

According to the present invention, in a solid state imaging device provided with a boosting circuit, a stable output signal can be obtained without being affected through stop of the operation of the boosting circuit.

Also, according to the present invention, in the solid state imaging device provided with the boosting circuit, it is not necessary to provide the invalid pixels in order to obtain the stable output signal. Thus, it is possible to configure the solid state imaging device with a small circuit area.

What is claimed is:

1. A solid state imaging device comprising:
a floating diffusion layer, a reset drain, and an absorption drain formed in a semiconductor substrate;
a charge transfer section configured to transfer electric charge into said floating diffusion layer in response to a transfer clock signal;
a reset transistor configured to transfer said electric charge from said floating diffusion layer into said reset drain in response to a reset pulse signal to reset said floating diffusion layer;
an absorption transistor configured to stabilize a voltage of said reset;
a boosting circuit configured to bias said absorption drain to a predetermined voltage based on said transfer clock signal; and
a timing control circuit configured to stop supply of said transfer clock signal to said boosting circuit and said charge transfer section, and to restart supply of said reset pulse signal to said reset transistor at a first time prior to restart of the supply of said transfer clock signal at a second time.

2. The solid state imaging device according to claim 1, further comprising:
an amplifying circuit connected with said floating diffusion layer to amplify a voltage signal based on said electric charge in said floating diffusion layer; and
a clamping circuit configured to apply a reference voltage to an output of said capacitor in response to a clamp pulse signal, and
said timing control circuit supplies said clamp pulse signal.

3. The solid state imaging device according to claim 2, wherein said timing control circuit supplies said clamp pulse signal when supplying said reset pulse signal and stops the supply of said clamp pulse signal when stopping the supply of said reset pulse signal.

4. The solid state imaging device according to claim 1, wherein said first time is predetermined such that an output signal of said solid state imaging device corresponding to said electric charge stored in said floating diffusion layer has a reference voltage.

5. The solid state imaging device according to claim 2, wherein said first time is predetermined such that an output signal of said solid state imaging device corresponding to said electric charge stored in said floating diffusion layer has a reference voltage.

6. The solid state imaging device according to claim 1, wherein said transfer clock signal comprises a first transfer clock signal and a second transfer clock signal.

7. The solid state imaging device according to claim 1, wherein said reset transistor is formed from said floating diffusion layer, said reset drain, and a reset gate electrode supplied with said reset pulse signal, and
said barrier transistor is formed from said reset drain, said absorption drain and a barrier gate electrode supplied with a constant voltage.

8. The solid state imaging device according to claim 1, wherein said timing control circuit stops the supply of said transfer clock signal to said boosting circuit and said charge transfer section when said electric charge is read out from a pixel to said charge transfer section.

9. An operation method of a solid state imaging device, comprising:
transferring electric charge into a floating diffusion layer of a charge transfer section in response to a transfer clock signal;
transferring said electric charge from said floating diffusion layer into a reset drain in response to a reset pulse signal;
transferring said electric charge from said reset drain into an absorption drain;
biasing said absorption drain to a predetermined voltage based on said transfer clock signal to absorb said electric charge;
stopping generation of said transfer clock signal; and
restarting the generation of said reset pulse signal at a first time prior to restart of the generation of said transfer clock signal at a second time.

10. The operation method according to claim 9, further comprising:
amplifying a voltage signal based on said electric charge in said floating diffusion layer;
cutting a DC component from the amplified voltage signal;
applying a reference voltage to an output of said capacitor in response to a clamp pulse signal; and
generating said clamp pulse signal.

11. The operation method according to claim 10, wherein said generating comprises:
generating said clamp pulse signal when said reset pulse signal is generated; and
stopping the generation of said clamp pulse signal when the supply of said reset pulse signal is stopped.

12. The operation method according to claim 9, wherein said first time is predetermined such that an output signal of said solid state imaging device corresponding to said electric charge stored in said floating diffusion layer has a reference voltage.

13. The operation method according to claim 10, wherein said first time is predetermined such that an output signal of said solid state imaging device corresponding to said electric charge stored in said floating diffusion layer has a reference voltage.

14. The operation method according to claim 9, wherein said transfer clock signal comprises a first transfer clock signal and a second transfer clock signal.

15. The operation method according to claim 9, wherein a reset transistor is formed from said floating diffusion layer, said reset drain, and a reset gate electrode supplied with said reset pulse signal, and
a barrier transistor is formed from said reset drain, said absorption drain and a barrier gate electrode supplied with a constant voltage.

16. The operation method according to claim 9, wherein said stopping generation of said transfer clock signal comprises:
stopping the generation of said transfer clock signal when said electric charge is read out from a pixel to said charge transfer section.
